(19) United States
(12) Patent Application Publication
(10) Pub. No.: US 2014/0196987 A1
(43) Pub. Date: Jul. 17, 2014

(54) DEVICE FOR POSITIONING A ROPE ACCESS TECHNICIAN IN RELATION TO A BLADE OF A WIND TURBINE

(71) Applicants: Joshua Crayton, Santa Cruz, CA (US); John DeWit, Scotts Valley, CA (US); Jean-Paul Cane, Seneca, SC (US); Randy Deputy, Flagstaff, AZ (US); David M. Granger, Santa Cruz, CA (US); Eric Stanfield, Santa Cruz, CA (US)

(72) Inventors: Joshua Crayton, Santa Cruz, CA (US); John DeWit, Scotts Valley, CA (US); Jean-Paul Cane, Seneca, SC (US); Randy Deputy, Flagstaff, AZ (US); David M. Granger, Santa Cruz, CA (US); Eric Stanfield, Santa Cruz, CA (US)

(73) Assignee: ROPE PARTNER, INC., Santa Cruz, CA (US)

(21) Appl. No.: 14/215,376

(22) Filed: Mar. 17, 2014

Related U.S. Application Data
(63) Continuation of application No. 13/112,236, filed on May 20, 2011, now abandoned.

(51) Int. Cl. F03D 1/00

(52) U.S. Cl. CPC F03D 1/003
USPC 182/130; 182/150; 182/142

(57) ABSTRACT

A device for positioning a rope access technician next to a blade of a wind turbine, including a rigid spine, one or more clamp assemblies with each clamp assembly connected to the rigid spine and each clamp assembly capable of clamping to a blade of a wind turbine, and a lower platform connected to a lower portion of the rigid spine with a substantially flat top surface on which a technician may sit, stand or place items.

### FIELD OF THE INVENTION

The present invention relates to wind turbine maintenance. More specifically, it concerns a device that positions and stabilizes a rope access technician, while suspended on his/her own independent rope access system, in relation to a blade of a wind turbine while working on the tip of the blade.

### BACKGROUND OF THE INVENTION

After initial installation, wind turbine blades are inspected, maintained and repaired from time-to-time as they can be damaged during transportation to the installation site, during installation or, for example, due to lightning, hail, dust storms, normal wear and tear, poor initial structural design and birds.

It is generally understood that the most difficult part of the blade to perform maintenance and repair upon is the tip, as it moves the most in the wind. For a technician to work effectively on the tip of the blade he/she must be positioned and stabilized next to the blade tip. One method of positioning a technician next to or on a blade tip is to be suspended using an industrial rope access system. An industrial rope access system typically includes ropes and a harness, with the ropes being anchored from the top of the turbine. A technician that performs maintenance on the blade of a wind turbine while suspended from ropes is referred to as a rope access technician. One challenge commonly encountered by a rope access technician, or also referred to herein as simply technician, is that the blade and the technician move independently of each other due to wind and weather. Another challenge faced by a technician is that there is nothing below the tip as a leverage point to stabilize himself/herself with while working. For example, using hand tools that require two hands on the tool to operate, does not leave any way to hold onto the blade or counteract the forces of the wind or the use of the tool.

Another challenge for the technician is that the blade typically cannot be locked out, or fixed, exactly vertically and, thus, the technician has to work at an angle. Yet another challenge is the lack of ability of the technician to stabilize the part of his or her body that dangles below the blade while working on the tip.

Another approach to gaining access to the tip of the blade is to suspend a platform or scaffolding from the top of the turbine on which a technician can stand or sit while working on the blade. Such prior art devices are typically referred to as suspended scaffoldings or platforms. Such platforms do not require the technician to be suspended on his/her own industrial rope access system as the platform serves as the support structure. Typically, technicians using such platforms are attached and secured to the platform itself. One problem with these platforms is that they are bulky and heavy and often cannot be readily checked in as luggage on a commercial airline. Another problem with these platforms is that they make use of more complex anchoring of cables or ropes from the top of the turbine, to support their weight, than a rope access system typically used by rope access technicians. Thus, it can be time consuming or difficult to erect or set up such a platform. Finally, being large and heavy, such devices may damage the blade when moving independently from the blade in the wind, or make it difficult for the technician to work on a support device that is moving independently from the blade. Even when such devices are partially fixed to the blade, for example using an elastic cable, such difficulties and dangers remain.

Therefore, it would be advantageous to have a positioning device that would not be the primary support of a technician, as is the case with the above mentioned platforms and scaffoldings, but rather be a lightweight, portable device to be used by a rope access technician in conjunction with a rope access system. It would further be advantageous to have a positioning device that is light and can be folded or disassembled so that it may be checked in as luggage and transported on commercial flights with the rest of his/her gear. It would be yet further advantageous to have a positioning device that affixes to a blade of a wind turbine and provides a stable platform that moves together with the blade instead of independently, enabling a rope access technician to work more effectively on the tip of the blade.

### SUMMARY OF THE DESCRIPTION

The present invention concerns a device for positioning a rope access technician at tip of a blade of a wind turbine. This device, although not the primary support for the rope access technician, who depends on an independent rope access system anchored to the top of the wind turbine to prevent him/her from falling, provides a stable platform on which a rope access technician may stand or sit while working. The invention includes a clamping device that applies compressive force against two opposing sides of the blade to maintain the positioning device in a fixed position relative to the blade.

One embodiment of the subject invention is directed toward a device for positioning a technician next to a blade of a wind turbine, including means for maintaining the positioning device in a fixed position by applying compressive force to two opposing sides of the blade, and a platform connected to the means for maintaining the positioning device in a fixed position on which the technician may stand or sit.

Another embodiment is directed toward a device for positioning a technician next to a blade of a wind turbine, including a rigid spine, one or more clamp assemblies each clamp assembly connected to the rigid spine and each clamp assembly capable of clamping to a blade of a wind turbine, and a lower platform connected to a lower portion of the rigid spine with a substantially flat top surface on which a technician may sit, stand, rest upon, or place items.

In yet another embodiment, there is a middle tube that includes an upper platform, on which a technician may inter alia place tools, sit, stand, or hold onto for additional support.

### BRIEF DESCRIPTION OF THE DRAWINGS

The present invention will be more fully understood and appreciated from the following detailed description, taken in conjunction with the drawings in which:

FIG. 1 is an illustration of a rope access technician standing on a positioning device that is clamped to a blade of a wind turbine, in accordance with an embodiment of the present invention;

FIG. 2A is an isometric view of a positioning device, seen from the front, in accordance with an embodiment of the present invention;

FIG. 2B is an isometric view of a positioning device, seen from the back, in accordance with an embodiment of the present invention;

FIG. 2C is an illustration of an alternative embodiment of a means for attaching a footrest to a lower tube such that the location of the footrest relative to the lower tube can be vertically adjusted, in accordance with an embodiment of the present invention;

FIG. 3A is a top view of the open position of a clamp arm assembly that clamps the positioning device to a blade of a wind turbine, in accordance with an embodiment of the present invention;

FIG. 3B is a top view of the closed position of a clamp arm assembly that clamps the positioning device to a blade of a wind turbine, in accordance with an embodiment of the present invention;

FIG. 3C is an isometric, cut-away, view of the open position of a clamp arm assembly that clamps a positioning device to a blade of a wind turbine, in accordance with an embodiment of the present invention;

FIG. 4 is a side view of an alignment bracket that secures and positions a blade of a wind turbine inside a positioning device, in accordance with an embodiment of the present invention;

FIG. 5A illustrates a footrest, on which a technician may stand, that may be positioned on either side of a positioning device, in accordance with an embodiment of the present invention;

FIG. 5B illustrates a technician standing on a footrest of a positioning device with the footrest angled to one side, in accordance with an embodiment of the present invention;

FIG. 6 illustrates a positioning device that is folded, in accordance with an embodiment of the present invention;

FIGS. 7A-B illustrate an alternative embodiment of a clamp assembly that clamps a positioning device to a blade of a wind turbine, in accordance with an embodiment of the present invention; and

FIG. 8 illustrates an alternative embodiment of a positioning device, in accordance with an embodiment of the present invention.

### DETAILED DESCRIPTION

The invention is described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as devices, methods, processes, and systems. The following detailed description is, therefore, not to be taken in a limiting sense.

The present invention concerns a positioning device that affixes to a wind turbine blade enabling a technician to work effectively on the tip of the blade. The positioning device is typically suspended by a rope to the top, or hub, of the wind turbine.

As used herein the following terms have the meaning given below:

Wind turbine or turbine or windmill—means a rotary device that extracts energy from wind. A wind turbine generally has two or more blades that are turned by the wind.

Blade—means a blade of a wind turbine.

Technician—means a rope access technician that performs installation, inspection, maintenance, or repair services of any kind on a blade using an industrial rope access system that includes ropes and a harness with the ropes being anchored from the top of the turbine.

Maintenance—refers to any task or operation performed by a technician on a blade including repair, installation, inspection and routine service.

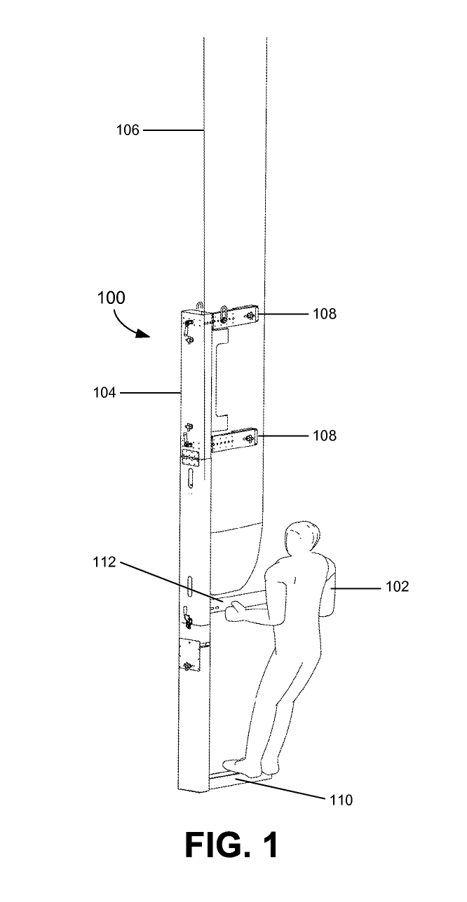

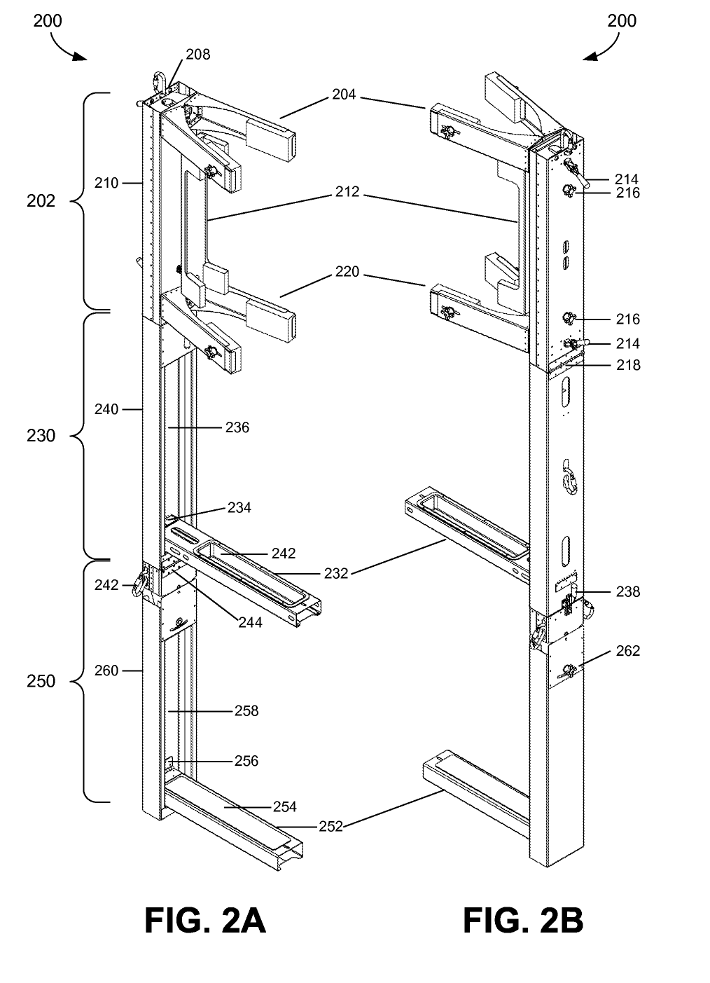

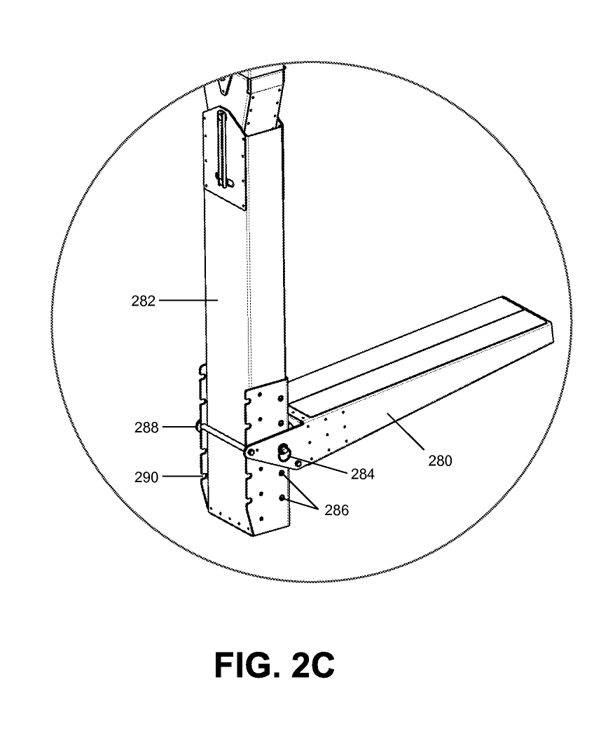

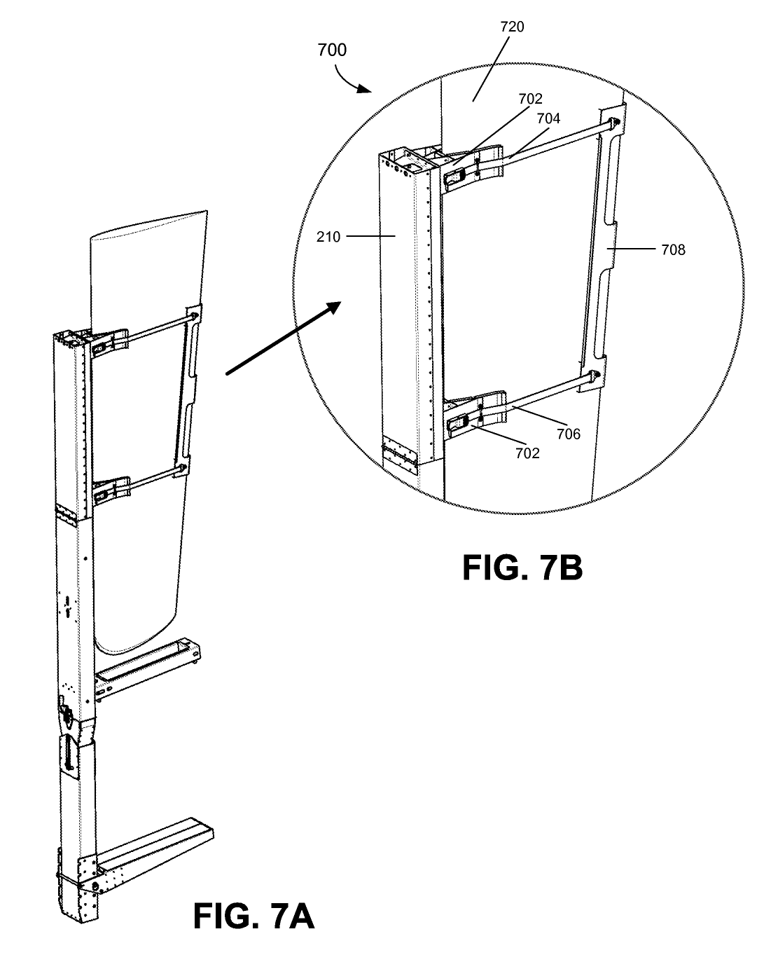

Now reference is made to FIG. 1, which is an illustration of a rope access technician 102 standing on a positioning device 100 that is clamped to a blade 106 of a wind turbine, in accordance with an embodiment of the present invention. Positioning device 100 attaches to blade 106 and provides a stable platform from which a technician 102 may perform maintenance on blade 106. Although not depicted in FIG. 1, positioning device 100 is typically suspended by a rope to the top of the wind turbine. A preferred embodiment of positioning device 100 is described further with reference to FIGS. 2A-C. Two additional embodiments of positioning device 100 are disclosed with reference to FIGS. 7A-B and 8.

In a preferred embodiment, positioning device 100 includes a rigid spine 104, and two clamp assemblies 108 that clamp to blade 106. Spine 104 typically consists of a plurality of connected segments. In a preferred embodiment, there are three connected segments and each can be folded against an adjacent segment to fit into a shape convenient for travel. Spine 104 may have inter alia a circular, rectangular, or triangular cross-section. Spine 104 is constructed of a rigid, relatively lightweight material such as inter alia sheet metal, metal alloy, or carbon fiber.

Each clamp assembly applies compressive force against opposing sides of blade 106 and thus stabilizes and positions positioning device 100 and, consequently, technician 102, next to blade 106. In other embodiments, more or less than two clamp assemblies may be employed or the clamps may be arranged in a different configuration. An example of an embodiment with an alternative clamping configuration is given in FIG. 7A-B. Further, clamping devices and devices other than those described herein may be used without departing from the scope and spirit of the subject invention. For example, suction cups, or comparable devices, may be employed rather than the rubber pads described herein to grip a blade.

Technician 102 is depicted as standing on a lower platform 110, also referred to herein as a footrest, and holding an upper platform 112 or support arm. This depiction is not intended to limit the manner in which technician 102 is supported by positioning device 102. Further, technician 102 will typically be suspended in a harness that is attached by ropes to the top of the wind turbine to which blade 106 attaches. In some working situations, said harness and ropes will support all of or a portion of the weight of technician 102 such that positioning device 100 does not need to support the entire weight of technician 102. However, said harness and ropes are not part of the subject invention.

Now reference is made to FIGS. 2A and 2B, which provide isometric views of a positioning device 200, in accordance with an embodiment of the present invention. FIG. 2A provides a front or inside view and FIG. 2B provides a back or outside view of positioning device 200, which is an embodiment of positioning device 100 in FIG. 1. In other embodiments of the subject invention not all the components of positioning device 200 described herein are required to practice the invention, and variations in the arrangement of, materials used and type of the components used may be made without departing from the spirit or scope of the present invention.

Positioning device 200 includes three interconnected tubular assemblies : upper tube assembly 202; middle tube assembly 230; and lower tube assembly 250. It may be appreciated by one skilled in the art that the term tube as used herein does not imply a particular shape or cross section, unless such a shape or cross section is specifically mentioned; thus the cross section of a tube may be inter alia circular, elliptical, triangular, or rectangular. The rigid spine is divided into three assemblies to enable it to be disassembled into a more compact form for purposes of transportation. In a preferred embodiment, described hereinbelow the three tubular assemblies are folded upon each other into a more compact form. Other approaches to disassembling the three assemblies into a more compact form include inter alia (1) disassembling the assemblies and placing them next to each other, and (2) sliding them one inside the other.

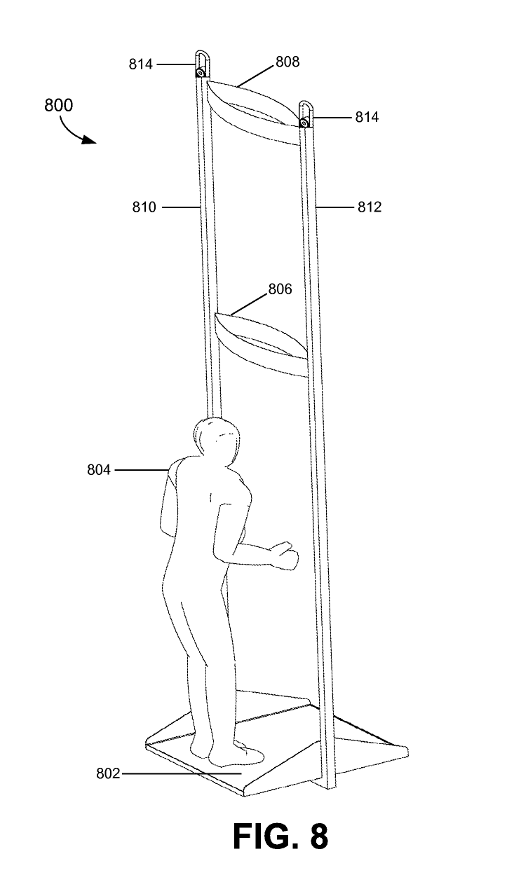

Upper tube assembly 202 includes a rectangular structural tube, upper tube 210, to which is attached two opposing identical clamp arm assemblies, upper clamp arm assembly 204 and lower clamp arm assembly 220, and one alignment bracket 212. Upper clamp arm assembly 204 and lower clamp arm assembly 220 are embodiments of clamp assembly 108 of FIG. 1. Each of upper clamp arm assembly 204 and lower clamp arm assembly 220 are hinged to upper tube 210. Two alternative embodiments of clamp assembly 108 are described with reference to FIG. 7A-B and FIG. 8.

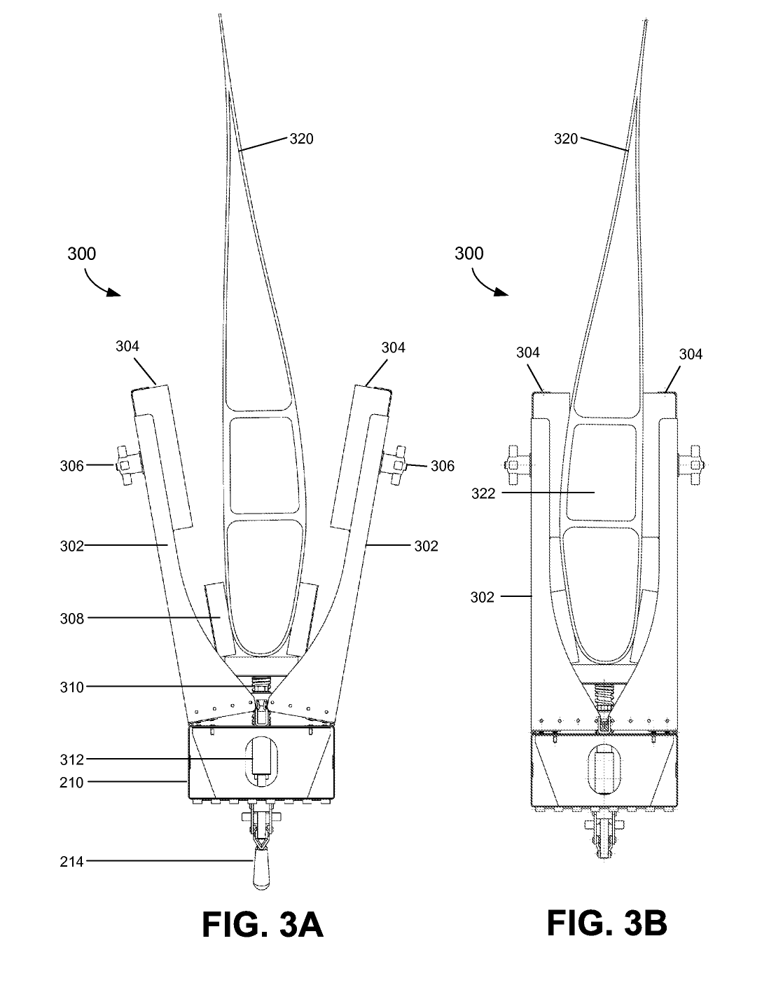

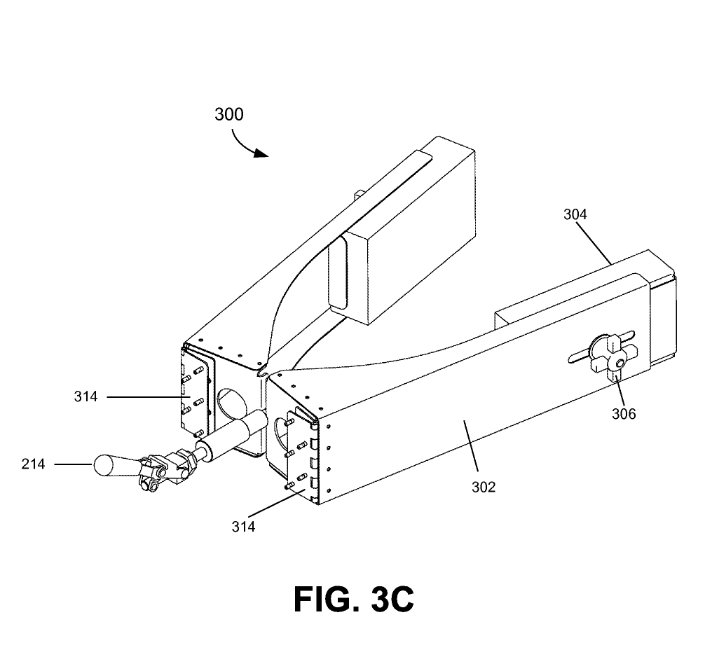

When closed, the two clamp arm assemblies compress against, or grip, the blade of a wind turbine such as blade 106 in FIG. 1. A preferred embodiment of a clamp assembly is described in greater detail below with reference to FIGS. 3A-C.

Typically, the blade of a wind turbine has a rigid structural component that runs the length of the blade, approximately down the center of the blade, to within approximately 1 meter of the blade tip. For example, the rigid structural component may be a shear web structure such as those used in the wings and other aerodynamic parts of aircraft, or may be one or more I-beams, channels, or closed sections known as a spar. The term spar is used henceforth to refer to such a rigid structural component. A spar may be constructed of metal, metal alloy, carbon fiber, wood, fiberglass or other such material. The length of upper clamp assembly 204 and lower clamp assembly 220 are determined so as to enable them to compress primarily against the spar inside a blade. In one embodiment the length of each of upper clamp assembly 204 and lower clamp assembly 220 is approximately 6 to 8 inches in length. The pressure applied by a clamp arm assembly to a blade is regulated by a technician using a quick acting clamp adjuster 214. In FIG. 2B, one clamp adjuster 214 is used to regulate the force applied by upper clamp assembly 204 and another clamp adjuster 214 is used to regulate the pressure applied by lower clamp assembly 220.

Upper tube 210 has a suspension mechanism 208 at the top enabling positioning device 200 to be suspended from the hub of a wind turbine. In a preferred embodiment, suspension mechanism 208 is implemented as three holes or cutaways. Typically, a carabineer is placed through one of the holes allowing positioning device 200 to be suspended by one or more ropes anchored from the top of a wind turbine. Positioning device 200 may be tilted to one side or the other by attaching a rope to one of the two side holes rather than to the center hole.

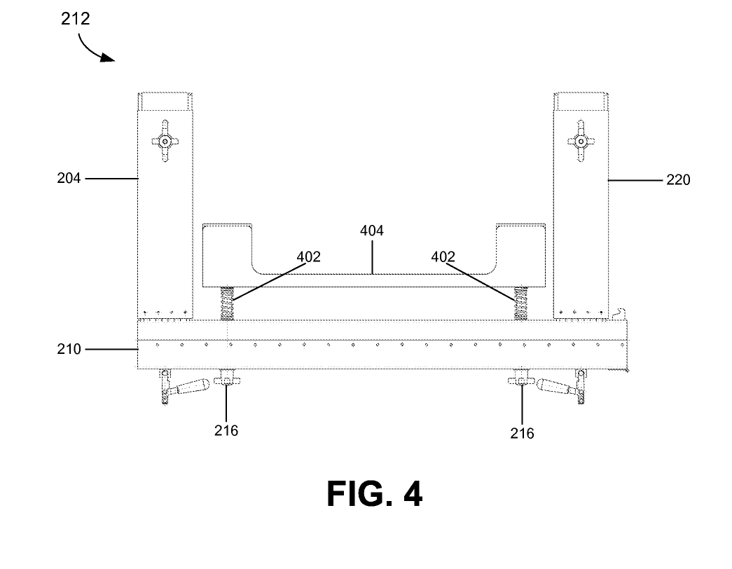

An alignment bracket 212 aligns positioning device 200 with the leading edge of the blade prior to clamping the blade in place using upper clamp arm assembly 204 and lower clamp arm assembly 220. A technician may adjust the distance and angle of alignment bracket 212 from upper tube 210 using two alignment bracket adjusters 216. Alignment bracket 212 is described in further detail with reference to FIG. 4.

Hinge 218, at the bottom of upper tube 210 enables middle tube 240 to fold upwards against upper tube 230, typically for purposes of storage or transport.

Middle tube assembly 202 includes a rectangular structural tube, middle tube 240, to which is attached, via hinge 234, a support arm 232.

Typically, support arm 232 is an upper platform that enables a technician to inter alia sit on it, hold onto it, or rest tools or other materials upon it. Support arm 232 attaches to middle tube 240 via a hinge 234 that enables support arm 232 to fold upwards into opening 236. Support arm 232 has a slot which engages a spring catch when in the folded position. When unfolded, in the outstretched position, as depicted in FIGS. 2A and 2B, the top of support arm 232 has a tray 242 that can hold tools or other items. There are cutouts on both sides of support arm 232 that may be used to attach items or straps. Support arm 232 may optionally be equipped with a seat or antiskid material. In one embodiment, support arm 232 is not present.

Middle tube 240 has cutouts 242 for attaching carabineers to hold tool buckets or other gear. In FIG. 2A, positioning device 200 is depicted with a carabineer attached through suspension mechanism 208. It may be appreciated that the carabineer itself is not a part of the subject invention. There are cutouts for carabineers on the back side of middle tube 240, not depicted, to attach a stabilizing rope to allow a technician on the ground to help control the device when attaching or detaching the device from the blade.

A quick-acting pull latch 238 locks middle tube 230 and lower tube 250 into a rigid, unfolded assembly.

In an alternative embodiment, support arm 232 attaches to lower tube 260. In yet another alternative embodiment, there are only two tubular assemblies, an upper tube such as upper tube 210 and a lower tube such as lower tube 260 and support arm 232 attaches to the lower tube or to the upper tube.

Lower tube assembly 250 includes a rectangular structural tube, lower tube 260, to which is attached a rectangular, rigid, footrest 252. Footrest 252, also referred to as a lower platform, attaches to lower tube 260 via hinge 256 and has a slot which engages a spring catch when in the folded position. Typically, a technician stands on footrest 252 while effecting maintenance on the blade tip. In one embodiment, the top of footrest 252 is coated with anti-skid material. Hinge 256 enables footrest 252 to fold into opening 258, typically for purposes of storage or transport.

Lower tube 260 is articulated so that, when viewed from the front of positioning device 200, footrest 252 can be moved to any angle within approximately plus or minus 15 degrees of the vertical axis formed by lower tube 260. A pivot adjuster, implemented in a preferred embodiment as hand knob 262, is used to lock lower tube 260 in any position. In operation, a technician twists hand knob 262 to loosen it, then moves lower tube 260 and footrest 252 to a desired position and then re-tightens hand knob 262. This tilt or pivot mechanism enables a technician to angle himself/herself forward or backward in relation to the blade to achieve an efficient position from which to perform maintenance.

At its top, lower tube 260 has a hinge 244 and a latch catch at the top to connect to middle tube 240.

In positioning device 200, upper tube 210, middle tube 240, and lower tube 260 together form rigid spine 104. In a preferred embodiment, the cumulative length of the three tubes, i.e. of rigid spine 104, is such that an adult technician of height between approximately 5′2″ to approximately 6′2″ can stabilize himself/herself using support arm 232 with his/her feet on footrest 252 and perform maintenance on the lower portion of a blade. Thus the overall length of the three tubes, or, equivalently, spine 104 is 6-16 feet, preferably 8-12 feet, and most preferably 9-11 feet. In one embodiment, upper tube 210 is most preferably 40″ inches long and middle tube 240 and lower tube 260 are each most preferably 44″ inches long. The lengths of each of the three tubes can be independently shorter or longer and the overall length of positioning device 200 can be shorter or longer without departing from the scope or spirit of the subject invention.

Further, in other embodiments only one or two tubular assemblies may be used. Further, in other embodiments the tubular assemblies have a circular or elliptical cross section rather than a rectangular cross section.

Now reference is made to FIG. 2C, which is an illustration of an alternative embodiment of a means for attaching a footrest to a lower tube such that the location of the footrest relative to the lower tube can be vertically adjusted, in accordance with an embodiment of the present invention. FIG. 2C presents an alternative design for connecting a footrest 280 to a lower tube 282 as part of the subject invention. Footrest 280 is an embodiment of footrest 110 and lower tube 282 is an alternative design of lower tube 260. Footrest 280 attaches to lower tube 282 using a lock pin 284 and a pin 288. A vertical position of the footrest 280 relative to lower tube 282 is established by selecting one of holes 286 and feeding lock pin 284 through it. Thus, each hole 286 in lower tube 282 enables footrest 280 to attach at a different vertical position. In the embodiment depicted in FIG. 2C five holes 286 are indicated, each affording a different vertical position; but more or less holes may be used without departing from the scope and spirit of the subject invention. Once one of holes 286 is selected and the footrest is moved to the appropriate position, pin 288 fits into a designated slot 290, providing additional support. The objective of the alternative embodiment illustrated in FIG. 2C is to enable technicians of different sizes to conveniently reach the lower meter or so of a blade as indicated in FIG. 1. In practice, a shorter technician will likely attach footrest 280 to one of the upper holes of holes 286 while a taller technician will likely attach footrest 280 to one of the lower holes of holes 286.

Now reference is made to FIG. 3A, which is a top view of the open position of a clamp arm assembly 300 that clamps the positioning device to a blade of a wind turbine, in accordance with an embodiment of the present invention. Upper clamp arm assembly 204 and lower clamp arm assembly 220 are instances of clamp arm assembly 300.

Clamp arm assembly 300 is symmetric and has two identical clamp arms 302. Clamp arm 302 is hinged to upper tube 210 at one end and has a pad 304 opposite end. Pad 304 connects to clamp arm 302 via a pad adjuster 306. Clamp arm assembly 300 also includes a leading edge cushion 308, a spring 310, a linkage 312, and clamp adjuster 214.

Pad adjuster 306 is used to adjust, or move, pad 304 laterally to achieve optimum positioning over the spar of the blade. Pad 304 is made of a compressible material such as foam rubber so that when it is compressed against the blade it won't break or fracture the blade surface.

Clamp adjuster 214 is used to open and close the two clamp arms 302 in unison. Clamp adjuster 214 connects to an extension 312 that pushes and pulls on each of the two hinges that connect the two clamp arms 302 to upper tube 210, opening and closing, respectively, clamp arms 302. Extension 312 limits the open travel and allows adjustment of the closed position thereby controlling the amount of pressure exerted on the blade.

A spring 310 fits over extension 312 and against a padded, V-shaped, bracket 308 that guides and positions the leading edge of the blade relative to positioning device 200. Bracket 308 may be adjusted to control the angle between positioning device 200 and the leading edge of the blade. When attaching the device to the blade, bracket 308 makes it possible to avoid damaging the blade when it is brought into contact with positioning device 200 prior to clamping.

Now reference is made to FIG. 3B, which is a top view of the closed position of clamp arm assembly 300 that clamps the positioning device to a blade of a wind turbine, in accordance with an embodiment of the present invention. FIG. 3B illustrates that when clamp arms 302 are closed, clamped, pad 304 presses against the surface of blade 320 directly above a spar 322.

Now reference is made to FIG. 3C, which is an isometric and cut-away view of the open position of clamp arm assembly 300 that clamps the positioning device to a blade of a wind turbine, in accordance with an embodiment of the present invention. As previously described, and as illustrated in FIG. 3C, pad adjuster 306 is used to adjust the position of pad 304 laterally relative to clamp arm 302 in order to achieve optimum positioning over the spar of the blade. FIG. 3C also shows two identical hinges 314 that open when clamp adjuster 214, implemented in a preferred embodiment as an over-center latch, is turned in one direction and close when clamp adjuster 214 is turned in the opposite direction. When hinge 314 opens, clamp arm 302 opens outward. When hinge 314 closes, clamp arm 302 moves inward, compressing, or applying force, against blade 320.

Now reference is made to FIG. 4, which is a side view of alignment bracket 212, described previously with reference to FIG. 2, that secures and positions a blade of a wind turbine inside a positioning device, in accordance with an embodiment of the present invention. Alignment bracket 212 attaches to upper tube 210 between upper clamp assembly 204 and lower clamp assembly 220 via two alignment bracket adjusters 216. Alignment bracket adjuster 216 is an adjustment knob threaded onto a bolt and spring assembly 402 that passes through a fitted hole in top tube 210 and attaches to a cushion assembly 404. Each of the two alignment bracket adjusters 216 turns independently of one another. Cushion assembly 404 acts as a guide for the blade on which maintenance is being performed. It prevents the blade from striking against top tube 210 and being damaged. Cushion assembly 404 is made of a firm but compressible material such as foam rubber. Turning alignment bracket adjuster 216 in one direction pushes cushion assembly 404 outwards, in the direction of the blade and turning in the other direction retracts cushion assembly 404 towards top tube 210. Typically, a technician uses the two alignment bracket adjusters 216 to position cushion assembly 404 such that the two clamps 304 are positioned on opposing sides of the blade directly above a spar.

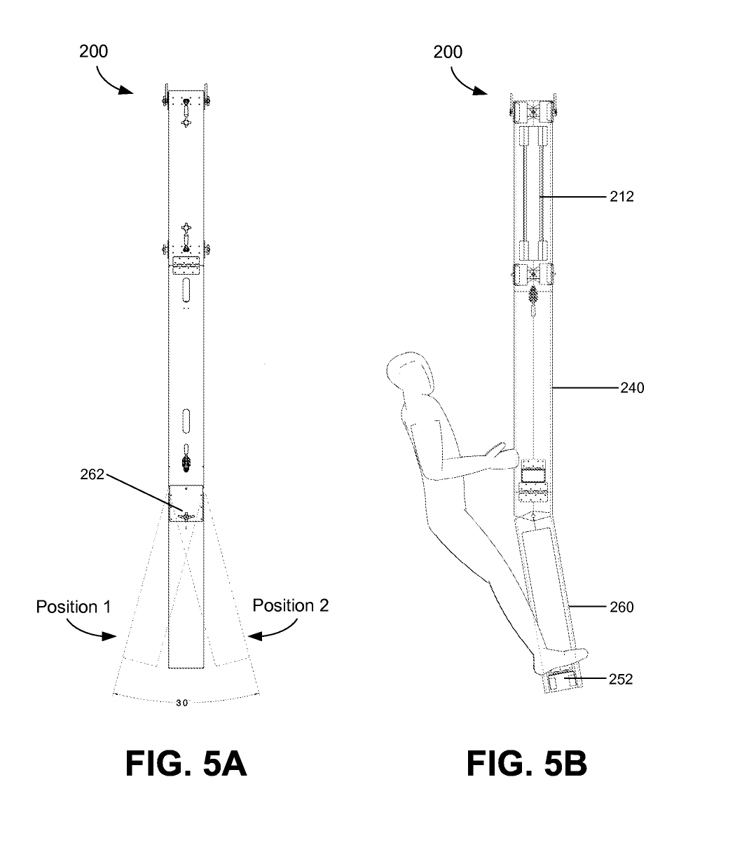

Now reference is made to FIG. 5A, which illustrates a footrest, on which a technician may stand, that may be positioned on either side of positioning device 200, in accordance with an embodiment of the present invention. As previously described a technician can tilt lower tube 260 to the right or left of the axis defined by upper tube 210 and middle tube 240 using pivot adjuster 262. In the embodiment depicted in FIG. 5A, lower tube 260 can tilt as much as 15 degrees to the left to reach position 1 and can tilt as much as 15 degrees to the right to reach position 2. Other embodiments of the subject invention may afford greater or lesser tilt capability than 15 degrees in either direction.

Now reference is made to FIG. 5B, which illustrates a technician standing on footrest 252 of positioning device 200 with footrest 252 angled to one side. In operation, a blade is typically positioned against alignment bracket 212. The blade tip typically reaches down to approximately the middle of middle tube 240. As depicted in FIG. 5B, tilting lower tube 260 away from the torso of the technician places the upper body and arms further away from middle tube 240, and hence the blade undergoing maintenance, providing the technician with greater freedom of movement. Not depicted is a harness around the technician and ropes from the top of the wind turbine to which the harness attaches, both of which are typically used. Also not depicted are ropes that suspend positioning device 200 from the hub of the wind turbine, which are typically used.

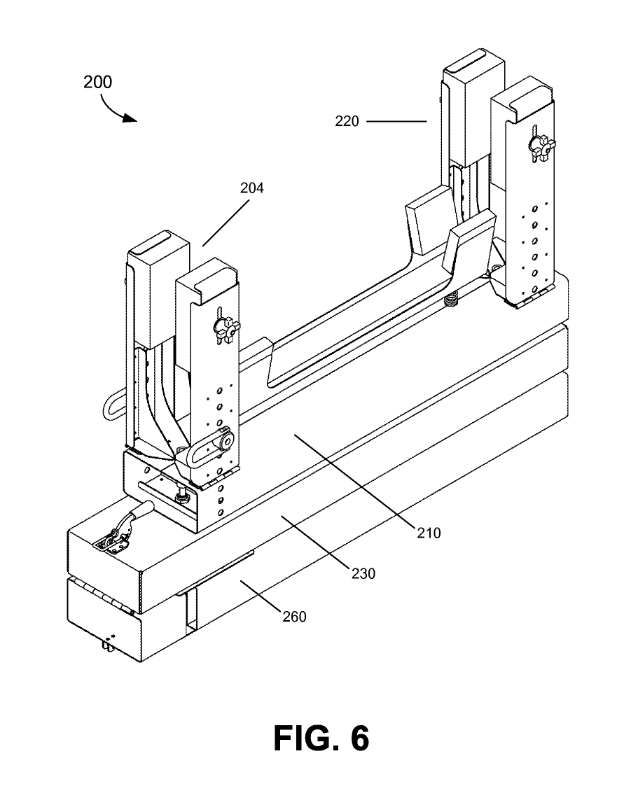

Now reference is made to FIG. 6, which illustrates positioning device 200 in a folded position, in accordance with an embodiment of the present invention. In FIG. 6, footrest 252 is folded into opening 258 and support arm 232 is folded into opening 236. Also, lower tube 260 is folded upward, against middle tube 240, and middle tube 240 is folded upward, against upper tube 210. In this embodiment, upper clamp assembly 204 and lower clamp assembly 220 do not fold. In other embodiments either or both of upper clamp assembly 204 and lower clamp assembly 220 may fold. In this embodiment, the length of the folded assembly, i.e. the length of middle tube 240 and the length of lower tube 260 is 44 inches. The height is approximately 36 inches. The depth, i.e. the depth of each of the four tubes, is typically in the range of 2″ to 16″. In the folded position, illustrated in FIG. 6, positioning device 200 can be easily picked up and carried by a single technician, assuming that fairly lightweight materials are used such as sheet metal, aluminum or carbon fiber. Further, a technician may bring positioning device 200 to an airport and check it in without having to have previously made special arrangements with an airlines. Thus, as described, positioning device 200 can be folded so as to be easily portable.

### Alternative Embodiments

Now reference is made to FIGS. 7A-B, which illustrate an alternative embodiment of a clamp assembly that clamps a positioning device to a blade of a wind turbine, in accordance with an embodiment of the present invention. Like clamp assemblies 204 and 220, alternative clamp assembly 700, illustrated in FIGS. 7A-7B, grips the blade of a turbine on opposing sides thus stabilizing the positioning device relative to the blade. Alternative clamp assembly 700 then can be seen as a replacement for clamp assemblies 204 and 220 serving the identical function for positioning device 200. Thus, in one embodiment, when alternative clamp assembly 700 is mounted on upper tube 210 clamp assemblies 204 and 220 are not used, i.e. they are replaced by alternative clamp assembly 700. In another embodiment, alternative clamp assembly 700 is used along with clamp assemblies 204 and 220 to enable positioning device 200 to better grip a blade of a wind turbine.

Alternative clamp assembly 700 includes an inner cuff 702, an adjustable upper tension strap 704, an adjustable lower tension strap 706 and an outer cuff 708. The inner cuff 702 attaches rigidly on one side to upper tube 210. On the other side, inner cuff 702 engages with the leading edge of a blade 720 of a wind turbine. Inner cuff 702 and outer cuff 708 connect at the top via upper tension strap 704 and at the bottom via lower tension strap 706. Inner cuff 702 and outer cuff 708 are made of metal or a similar rigid material each padded to positively grip the leading and trailing edges respectively and to preclude any contact of the blade with the rigid parts of the cuffs. Both upper tension strap 704 and lower tension strap 706 have buckles which allow tensioning the straps. A technician adjusts upper tension strap 704 and lower tension strap 706 to a level of tension such that adequate pressure is exerted by inner cuff 702 and outer cuff 708 upon blade 720 to keep positioning device 200 from moving when weight is added to it, e.g. when a technician stands on it or places tools on it.

Now reference is made to FIG. 8, which illustrates an alternative embodiment of a positioning device 800, in accordance with an embodiment of the present invention. Positioning device 800 is an embodiment of positioning device 100 in which spine 104 is formed by a left tube 810 and a right tube 812. Like positioning device 200, positioning device 800 grips the blade of a turbine on opposing sides thus stabilizing its position relative to the blade, and provides a platform on which a technician may stand or sit. In operation, positioning device 800 is raised from the ground on ropes attached from the top of the wind turbine through two lift eyes 814. A blade of the wind turbine is fit first through upper clamp assembly 808 and then through lower clamp assembly 806. Once the blade reaches the desired position relative to positioning device 800, technician 804 secures upper clamp assembly 808 and lower clamp assembly 806 to the blade. Upper clamp assembly 808 and lower clamp assembly 806 are identical, thus the operation of only one, upper clamp assembly 808, is described herein. In one embodiment, upper clamp assembly 808 consists of two rubber straps that attach both to left tube 810 and to right tube 812, each rubber strap securing one side of the blade. Then, technician 804 cinches the rubber strap using a buckle, not depicted. Thus, upper clamp assembly 808 exerts compressive force on the front and back of the blade.

Left tube 810 and right tube 812 are rigid structural supports made of a lightweight, durable, strong material such as metal or aluminum or carbon fiber. Left tube 810 and right tube 812 attach to opposing sides of platform 802.

Platform 802 is a rigid support on which technician 804 may stand or sit. In addition, tools and/or a toolbox or other items may be placed on top of platform 802. Platform 802 is made of a rigid, durable material such as sheet metal. In another embodiment, platform 802 is larger in size and may support two or more technicians.

Although not depicted, technician 804 typically wears a harness and is attached by ropes to the top of the wind turbine. The rope and harness typically support a portion of the weight of a technician.

In one embodiment, an alignment bracket, similar to alignment bracket 212 is attached to the inside of left tube 810 and right tube 812 and is used to both protect the blade and position it between left tube 810 and right tube 812.

In reading the above description, persons skilled in the art will realize that there are many apparent variations that can be applied to the device described.

What is claimed is:

1. A positioning device for positioning a technician next to a blade of a wind turbine, comprising:
a rigid spine;
means for maintaining the positioning device in a stable position by applying compressive force to a blade of a wind turbine, said means for maintaining the positioning device connected to the rigid spine; and
a lower platform connected substantially at the bottom of the rigid spine on which the technician may stand, sit, rest or place items.

2. The device of claim 1 wherein the lower platform can be folded upwards, against the rigid spine.

3. The device of claim 1 wherein the rigid spine comprises a plurality of connected segments.

4. The device of claim 3 wherein each of the plurality of connected segments can be folded against an adjacent segment.

5. The device of claim 1 wherein the position of the lower platform in relation to the rigid spine can be adjusted vertically.

6. The device of claim 2 further comprising an upper platform, that connects, above the lower platform, to the rigid spine, said upper platform having a substantially flat top surface on which a technician may sit, stand or place items.

7. The device of claim 1, further comprising means for connecting the device to a rope suspended from the top of the wind turbine.

8. A positioning device for positioning a technician next to a blade of a wind turbine, comprising:
a rigid spine;
one or more clamp assemblies, each clamp assembly connected to the rigid spine and each clamp assembly capable of clamping to a blade of a wind turbine; and
a lower platform connected substantially at the bottom of the rigid spine, said lower platform having a substantially flat top surface on which a technician may sit, stand, rest or place items.

9. The device of claim 8, wherein the rigid spine is eight to twelve feet in length.

10. The device of claim 8, wherein each clamp assembly exerts compressive force against opposing faces of the blade.

11. The device of claim 8, wherein said one or more clamp assemblies consists of a single clamp assembly that exerts compressive force against the leading edge and trailing edge of the blade.

12. The device of claim 8, wherein the position of the lower platform can be adjusted vertically along the rigid spine.

13. The device of claim 8, wherein the rigid spine comprises an upper tube and a lower tube.

14. The device of claim 13 wherein each of said one or more clamp assemblies connect to the upper tube and the lower platform connects to the lower tube.

15. The device of claim 13, wherein said one or more clamp assemblies consists of two clamp assemblies further comprising an alignment bracket connected to the upper tube that positions the blade in relation to the two clamp assemblies.

16. The device of claim 13 wherein the lower platform may be folded against the lower tube and the lower tube may be folded against the upper tube.

17. The device of claim 13, wherein the lower tube may be tilted either towards or away from the blade.

18. The device of claim 13, further comprising:
a middle tube connected at one end to the upper tube and at the other end to the lower tube; and
an upper platform connected to either the middle tube or the lower tube, said upper platform having a substantially flat top surface on which a technician may sit, stand or place items.

19. The device of claim 18 wherein the lower platform may be folded against the lower tube, the upper platform may be folded against the middle tube, and the middle tube may be folded against the upper tube
